(19) United States
(12) Patent Application Publication
(10) Pub. No.: US 2025/0183658 A1
(43) Pub. Date: Jun. 5, 2025

(54) VEHICLE POWER SUPPLY SYSTEM

(71) Applicant: Honda Motor Co., Ltd., Tokyo (JP)

(72) Inventors: Takuya Inazumi, Tokyo (JP); Yuhei Matsuo, Tokyo (JP)

(21) Appl. No.: 18/964,035

(22) Filed: Nov. 29, 2024

(30) Foreign Application Priority Data
Dec. 5, 2023 (JP) 2023-205014

(51) Int. Cl. H02J 1/08; B60L 1/00; B60L 50/60; H02J 7/34

(52) U.S. Cl. CPC H02J 1/086; B60L 1/00; H02J 7/345; B60L 50/60

(57) ABSTRACT

A vehicle power supply system includes: a first power supply system configured to supply power from a first power supply to a first load related to travel control of a vehicle, and a second power supply system configured to supply power from a second power supply to a second load related to the travel control of the vehicle. The vehicle power supply system further includes: a system connection unit capable of connecting and disconnecting the first power supply system and the second power supply system, a power supply connection unit capable of connecting and disconnecting the second power supply and the second load, and a microprocessor configured to, when an abnormality of the second power supply is detected, perform switching the power supply connection unit from a connection state to a disconnection state and switching the system connection unit from a disconnection state to a connection state.

### CROSS-REFERENCE TO RELATED APPLICATION

This application is based upon and claims the benefit of priority from Japanese Patent Application No. 2023-205014 filed on Dec. 5, 2023, the content of which are incorporated herein by reference.

### BACKGROUND OF THE INVENTION

### Field of the Invention

This invention relates to a vehicle power supply system mounted on a vehicle.

### Description of the Related Art

As this type of technology, there is known a vehicle power supply system that improves system reliability by multiplexing and redundantly providing at least some of functions of a control device 1A and a control device 1B (see, for example, JP 2020-152139 A).

In the conventional technology, a battery is required for each of a power supply system including the control device 1A and a power supply system including the control device 1B, which is a factor that hinders cost reduction and miniaturization of the vehicle power supply system.

The energy efficiency can be improved by reducing the size and weight of the vehicle power supply system. In addition, the cost reduction of the vehicle power supply system accelerates the spread of the vehicle power supply system, and can contribute to the development of a sustainable transportation system.

### SUMMARY OF THE INVENTION

An aspect of the present invention is a vehicle power supply system including: a first power supply system configured to supply power from a first power supply to a first load related to travel control of a vehicle; and a second power supply system configured to supply power from a second power to a second load related to the travel control of the vehicle. The vehicle power supply system further includes: a system connection unit capable of connecting and disconnecting the first power supply system and the second power supply system; a power supply connection unit capable of connecting and disconnecting the second power supply and the second load; and a microprocessor. The microprocessor is configured to when an abnormality of the second power supply is detected, perform switching the power supply connection unit from a connection state to a disconnection state and switching the system connection unit from a disconnection state to a connection state.

### BRIEF DESCRIPTION OF THE DRAWINGS

The objects, features, and advantages of the present invention will become clearer from the following description of embodiments in relation to the attached drawings, in which:

FIG. 1 is a schematic diagram illustrating a configuration of a vehicle power supply system according to an embodiment;

FIG. 2A is a schematic diagram illustrating the vehicle power supply system;

FIG. 2B is a schematic diagram illustrating the vehicle power supply system;

FIG. 2C is a schematic diagram illustrating the vehicle power supply system;

FIG. 2D is a schematic diagram illustrating the vehicle power supply system;

FIG. 3 is a flowchart illustrating a flow of switching control of switches;

FIG. 4 is a schematic diagram illustrating a configuration of the vehicle power supply system according to a first modification;

FIG. 5 is a schematic diagram illustrating a configuration of the vehicle power supply system according to a second modification;

FIG. 6A is a schematic diagram illustrating the vehicle power supply system;

FIG. 6B is a schematic diagram illustrating the vehicle power supply system;

FIG. 6C is a schematic diagram illustrating the vehicle power supply system; and

FIG. 6D is a schematic diagram illustrating the vehicle power supply system.

### DETAILED DESCRIPTION OF THE INVENTION

An embodiment of the invention will be described below with reference to the drawings.

### Overview

A vehicle power supply system according to an embodiment of the present invention improves system reliability by multiplexing and redundantly providing at least some of functions of a first load as a first control device and a second load as a second control device, and achieves cost reduction and miniaturization by providing a battery in only one of a first power supply system including the first load and a second power supply system including the second load, as compared with a vehicle power supply system including a battery in each of the first power supply system and the second power supply system.

Such a vehicle power supply system will be described in detail below.

### Configuration of Vehicle Power Supply System

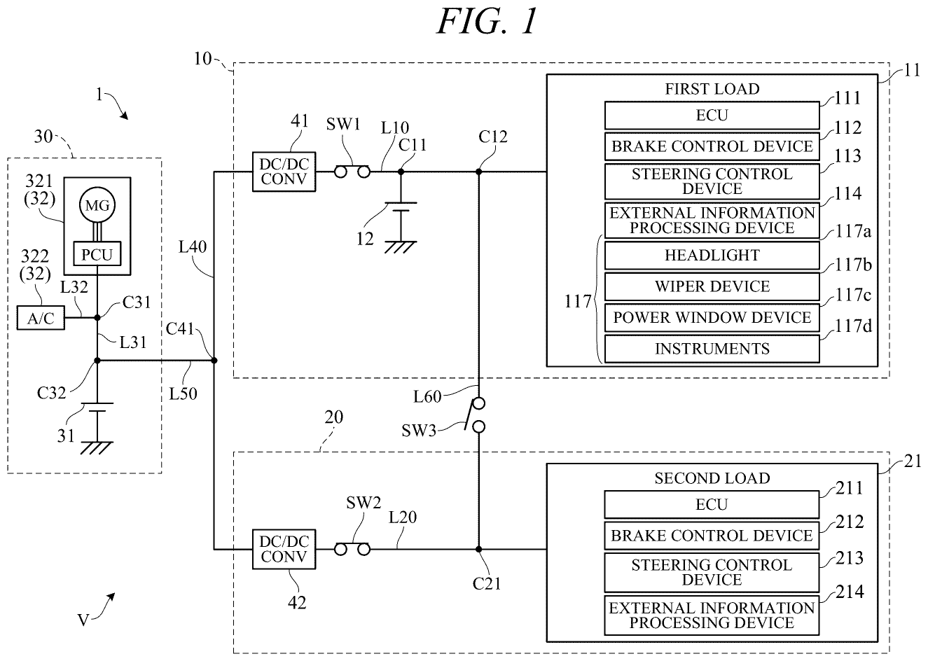

FIG. 1 is a schematic diagram illustrating a configuration of a vehicle power supply system 1, which is a vehicle power supply system mounted on a vehicle V, according to an embodiment. An operation state of switches SW1, SW2, and SW3 included in FIG. 1 indicates an operation state at a normal condition.

In the embodiment, the normal condition refers to a case where no abnormality to be described later occurs in the vehicle power supply system 1 in a state where an ignition (IG) switch (not illustrated) is turned on. In addition, setting the switches SW1, SW2, and SW3 to the switching state illustrated in FIG. 1 is referred to as normal setting.

The vehicle power supply system 1 includes a first power supply system 10, a second power supply system 20 provided in parallel with the first power supply system 10, a high-voltage power supply system 30 having a higher voltage than those of the first power supply system 10 and the second power supply system 20, and a system connection unit (the switch SW3, more specifically, a connection line L60 and the switch SW3) capable of switching connection and disconnection between the first power supply system 10 and the second power supply system 20.

### First Power Supply System

A power supply system that supplies power to a first load 11 will be referred to as the first power supply system 10. The first power supply system 10 includes a first power supply 41, the first load 11, the switch SW1 as a first power supply connection unit capable of switching connection and disconnection between the first power supply 41 and the first load 11, and a first battery 12 connected to the first load 11 side of the switch SW1.

### First Power Supply

The first power supply 41 includes a DC-DC converter that converts a DC voltage (for example, 200 [V]) supplied from the high-voltage power supply system 30 into a voltage required by the first load 11. The first power supply 41 outputs a DC voltage (for example, 12 [V]) after DC-DC conversion.

### Switch SW1

The first power supply 41 and the first load 11 are connected via a power line L10. The switch SW1 is provided on the first power supply 41 side of the power line L10. The switch SW1 is, for example, a normally open type (N.O. type) switch including a semiconductor switch. The normally open type switch is turned off in a case where a switching control signal is not input, and can be switched on/off in a case where the switching control signal is input. Therefore, with a configuration that the switching control signal to the on state is input to the switch SW1 during the normal condition, the DC voltage DC-DC converted by the first power supply 41 is supplied to the first load 11 via the switch SW1 in the on state and the power line L10.

Note that the switching of the switch SW1 is controlled by using at least power from the first power supply 41 of the first power supply system 10. In other words, during the normal condition, an ECU 111 to be described in detail later receives the power from the first power supply 41 of the first power supply system 10 and controls the switching of the switch SW1. On the other hand, in a case where the ECU 111 cannot receive power supply from the first power supply 41, another control device (not illustrated) that operates by receiving power from the high-voltage power supply 31 of the high-voltage power supply system 30 may be configured to control the switching of the switch SW1, thereby providing redundancy.

### First Load

The first load 11 includes a load performing a function regarding a travel operation, a stop operation, or driving control of the vehicle V for a self-driving (AD) capability. As an example, the first load 11 includes at least one of an auxiliary load used for an electronic control unit (ECU) or the like to perform driving control for AD of the vehicle V, an auxiliary load used to perform braking for AD of the vehicle V, an auxiliary load used to perform steering for AD of the vehicle V, or an auxiliary load used for a light detection and ranging (LiDAR), a camera, or the like to acquire external information for AD of the vehicle V.

In the embodiment, the first load 11 includes the ECU 111 used to perform driving control for AD of the vehicle V, a brake control device 112 that controls a braking device used to perform braking for AD of the vehicle V, a steering control device 113 that controls a steering device used to perform steering for AD of the vehicle V, and an external information processing device 114 that processes input information for AD from a LiDAR or a camera used to acquire external information of the vehicle V.

Further, the first load 11 has an emergency non-priority auxiliary load 117 as an auxiliary load other than the auxiliary load for AD described above. The emergency non-priority auxiliary load 117 includes, for example, a headlight 117a, a wiper device 117b, a power window device 117c, and instruments 117d.

Note that in a case where the vehicle V includes an engine (not illustrated), the first load 11 may include a starter motor (not illustrated) that starts the engine.

### First Battery

The first battery 12 includes a secondary battery that can be repeatedly charged and discharged. In the embodiment, for example, the first battery 12 is constituted by a lithium ion battery. Accordingly, it is possible to easily and accurately estimate the state of the first battery 12 by known means and methods. The first battery 12 outputs power at a voltage of, for example, 12 [V].

In the first battery 12, a positive electrode is connected to a contact point C11 formed on the first load 11 side of the switch SW1 in the power line L10, and a negative electrode is connected to a ground line having a reference potential of the vehicle power supply system 1. Note that although not illustrated, a charge/discharge control circuit for the secondary battery is provided, so that the first battery 12 is protected from overcharge and overdischarge.

### Second Power Supply System

A power supply system that supplies power to a second load 21 will be referred to as the second power supply system 20. The second power supply system 20 includes a second power supply 42, the second load 21, and the switch SW2 as a second power supply connection unit capable of switching connection and disconnection between the second power supply 42 and the second load 21.

Unlike the first power supply system 10, the second power supply system 20 does not include a secondary battery such as the first battery 12.

### Second Power Supply

The second power supply 42 includes a DC-DC converter that converts a DC voltage (for example, 200 [V]) supplied from the high-voltage power supply system 30 into a voltage required by the second load 21. The second power supply 42 outputs a DC voltage (for example, 12 [V]) after DC-DC conversion.

### Switch SW2

The second power supply 42 and the second load 21 are connected via a power line L20. The switch SW2 is provided on the second power supply 42 side of the power line L20. Similarly to the switch SW1, the switch SW2 is, for example, a normally open type (N.O. type) switch including a semiconductor switch. Therefore, with a configuration that the switching control signal to the on state is input to the switch SW2 during the normal condition, the DC voltage DC-DC converted by the second power supply 42 is applied to the second load 21 via the switch SW2 in the on state and the power line L20.

Note that the switching of the switch SW2 is controlled by using power from one of the second power supply 42 of the second power supply system 20 and the high-voltage power supply 31 of the high-voltage power supply system 30. In other words, during the normal condition, an ECU 211 to be described in detail later receives the power from the second power supply 42 of the second power supply system 20 and controls the switching of the switch SW2. On the other hand, in a case where the ECU 211 cannot receive power supply from the second power supply 42, another control device (not illustrated) that operates by receiving power from the high-voltage power supply 31 of the high-voltage power supply system 30 controls the switching of the switch SW2, thereby providing redundancy.

### Second Load

The second load 21 includes a load performing a function regarding a travel operation, a stop operation, or driving control of the vehicle V for an advanced driving assistance system (ADAS) function. The second load 21 performs a function regarding execution of a minimal risk maneuver (MRM) which is minimum travel operations, stop operations, and driving control necessary for safely moving the vehicle V to a road shoulder or the like and stopping the vehicle V even in a case where an abnormality occurs in the first power supply system 10.

As an example, the second load 21 includes at least one of an auxiliary load used for an ECU or the like to perform driving control for ADAS of the vehicle V, an auxiliary load used to perform braking for ADAS of the vehicle V, an auxiliary load used to perform steering for ADAS of the vehicle V, or an auxiliary load used for a LiDAR, a camera, or the like to acquire external information for ADAS of the vehicle V.

In the embodiment, the second load 21 includes the ECU 211 used to perform driving control for ADAS of the vehicle V, a brake control device 212 that controls a braking device used to perform braking for ADAS of the vehicle V, a steering control device 213 that controls a steering device used to perform steering for ADAS of the vehicle V, and an external information processing device 214 that processes input information for ADAS from a LiDAR or a camera used to acquire external information of the vehicle V.

A part of the loads included in the second load 21 of the second power supply system 20 overlaps with a partial function of the first load 11 of the first power supply system 10. Specifically, the ECU 211 of the second load 21 has a function overlapping with the ECU 111 of the first load 11, the brake control device 212 of the second load 21 has a function overlapping with the brake control device 112 of the first load 11, the steering control device 213 of the second load 21 has a function overlapping with the steering control device 113 of the first load 11, and the external information processing device 214 of the second load 21 has a function overlapping with the external information processing device 114 of the first load 11.

As described above, by overlapping some functions between the second load 21 of the second power supply system 20 and the first load 11 of the first power supply system 10, it is possible to multiplex and redundantly provide the function regarding the execution of the MRM which is minimum travel operations, stop operations, and driving control necessary for safely moving the vehicle V to a road shoulder or the like and stopping the vehicle V even in a case where an abnormality occurs in the first power supply system 10 or the second power supply system 20. That is, it is possible to provide the vehicle power supply system 1 in which even in a case where an abnormality occurs in any one of the first power supply system 10 or the second power supply system 20, and the load of any one of the first load 11 or the second load 21 stops functioning, the MRM is executed by using the load of another power supply system, thereby ensuring traffic safety.

### High-Voltage Power Supply System

The high-voltage power supply system 30 includes the high-voltage power supply 31 and a high-voltage load 32. The high-voltage power supply 31 and the high-voltage load 32 are connected via a power line L31 and a power line L32.

### High-Voltage Power Supply

For example, the high-voltage power supply 31 is constituted by a secondary battery such as a lithium ion battery. The high-voltage power supply 31 outputs DC power having a voltage (for example, 200 [V]) higher than that of the first battery 12. Note that although not illustrated, the high-voltage power supply 31 is provided with a charge/discharge control circuit for the secondary battery, and the secondary battery constituting the high-voltage power supply 31 is protected from overcharge and overdischarge.

The high-voltage power supply 31 has a positive electrode side connected to a contact point C32 formed on the power line L31, and a negative electrode side connected to a ground line having a reference potential of the vehicle power supply system 1.

### High-Voltage Load

The high-voltage load 32 operates at a higher voltage (for example, 200 [V]) than those of the first load 11 and the second load 21. In the embodiment, the high-voltage load 32 includes a drive unit 321 that drives the vehicle V, and an air conditioner 322 that adjusts a temperature in a cabin of the vehicle V.

The drive unit 321 includes a rotating electrical machine MG that generates power for driving the vehicle V, and a power control unit PCU that controls the rotating electrical machine MG. The power control unit PCU includes a DC-DC converter, an inverter, and the like.

The drive unit 321 is connected to a contact point C31 formed on the power line L31. The drive unit 321 converts the DC power supplied from the high-voltage power supply 31 via the power line L31 into three-phase AC power by the power control unit PCU and supplies the three-phase AC power to the rotating electrical machine MG. Then, the rotating electrical machine MG generates power for driving the vehicle V by the three-phase AC power. In addition, the drive unit 321 generates three-phase AC power by the rotating electrical machine MG at the time of braking of the vehicle V, converts the three-phase AC power into DC power by the power control unit PCU, and charges the high-voltage power supply 31 via the power line L31.

The air conditioner 322 is connected to the contact point C31 via the power line L32. The air conditioner 322 is operated by the DC power supplied from the high-voltage power supply 31.

### Connection Between High-Voltage Power Supply System and First And Second Power Supply Systems

The high-voltage power supply system 30 and the first power supply system 10, and the high-voltage power supply system 30 and the second power supply system 20 are connected via a power line L50 and a power line L40.

In the power line L50, one end is connected to the contact point C32 of the high-voltage power supply system 30, and the other end is connected to the contact point C41 formed on the power line L40.

In the power line L40, one end is connected to the input side of the first power supply 41, and the other end is connected to the input side of the second power supply 42. The contact point C41 formed on the power line L40 is connected to the positive electrode of the high-voltage power supply 31 via the power line L50.

With the above connection, the DC power from the high-voltage power supply 31 is supplied to the first power supply 41 and the second power supply 42 via the power line L50 and the power line L40.

### System Connection Unit

The connection line L60 and the switch SW3 as a system connection unit switch between a connection state and a disconnection state between the first power supply system 10 and the second power supply system 20.

In the connection line L60, one end is connected to the contact point C12 formed on the power line L10 of the first power supply system 10, and the other end is connected to the contact point C21 formed on the power line L20 of the second power supply system 20.

### Switch SW3

The switch SW3 is provided on the connection line L60 such that the connection state and the disconnection state of the connection line L60 can be switched. The switch SW3 is, for example, a normally closed type (N.C. type) switch including a semiconductor switch. The normally closed type switch is turned on in a case where a switching control signal is not input, and can be switched on/off in a case where the switching control signal is input. Therefore, with a configuration that the switching control signal to the off state is input to the switch SW3 during the normal condition, the connection line L60 is maintained in the disconnection state.

Note that the switching of the switch SW3 is controlled by using power from one of the first power supply 41 of the first power supply system 10 or the second power supply 42 of the second power supply system 20, and the high-voltage power supply 31 of the high-voltage power supply system 30. In other words, during the normal condition, the ECU 111 that has received power from the first power supply 41 of the first power supply system 10 or the ECU 211 that has received power from the second power supply 42 of the second power supply system 20 controls the switching of the switch SW3. On the other hand, in a case where the ECU 111 (or ECU 211) which has performed the switching control cannot receive the power supply from the first power supply 41 (or the second power supply 42), another control device (not illustrated) which operates by receiving power from the high-voltage power supply 31 of the high-voltage power supply system 30 controls the switching of the switch SW3, thereby providing redundancy.

### Operation When Vehicle Power Supply System is Abnormal

Next, an operation of the vehicle power supply system 1 in a case where an abnormality occurs in the vehicle power supply system 1, that is, a case where the vehicle power supply system 1 is different from the normal condition will be described. Specifically, the switching control of the switches SW1, SW2, and SW3 will be described.

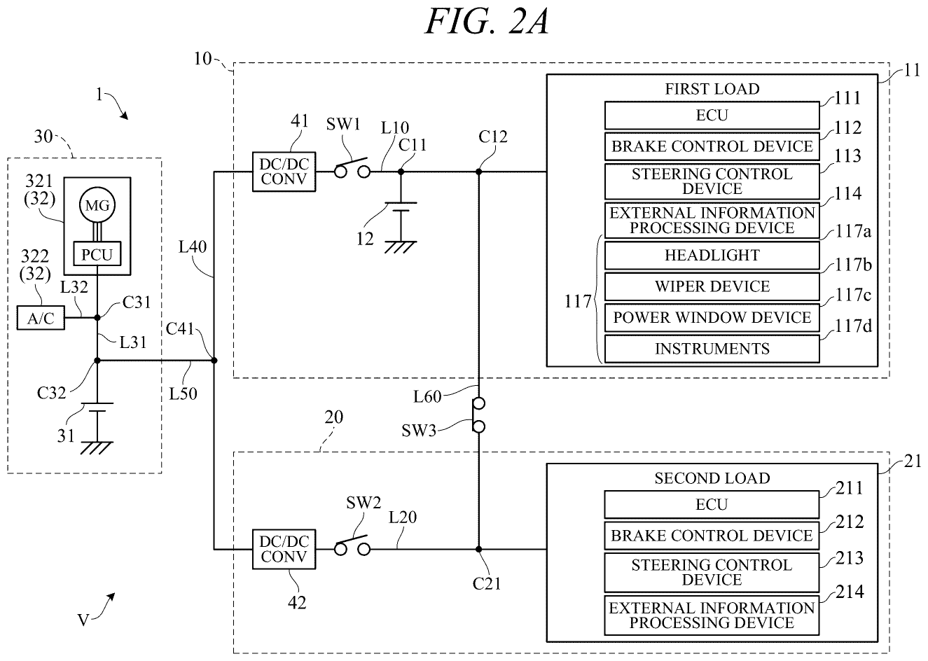

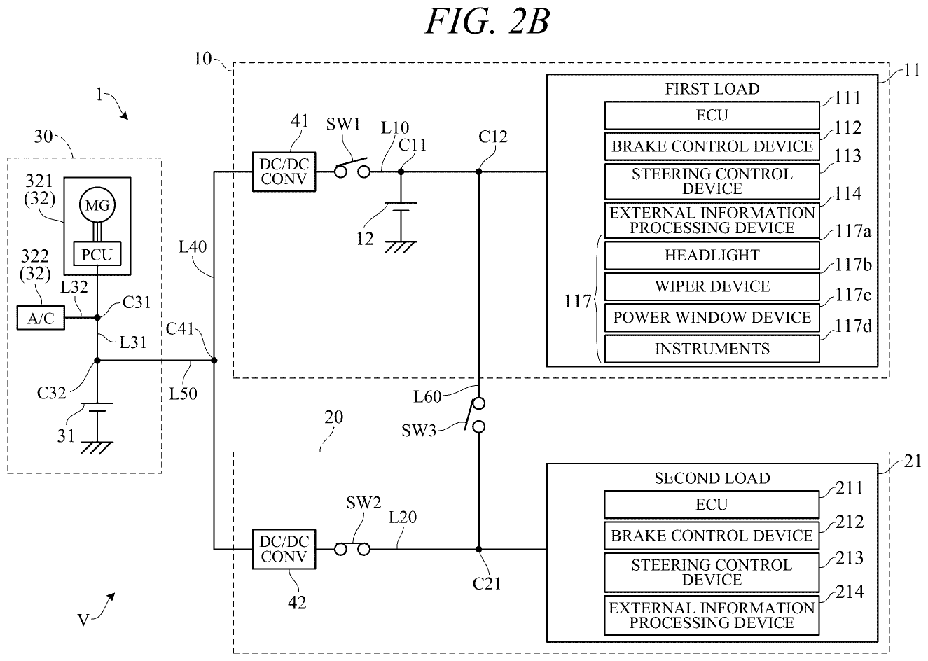

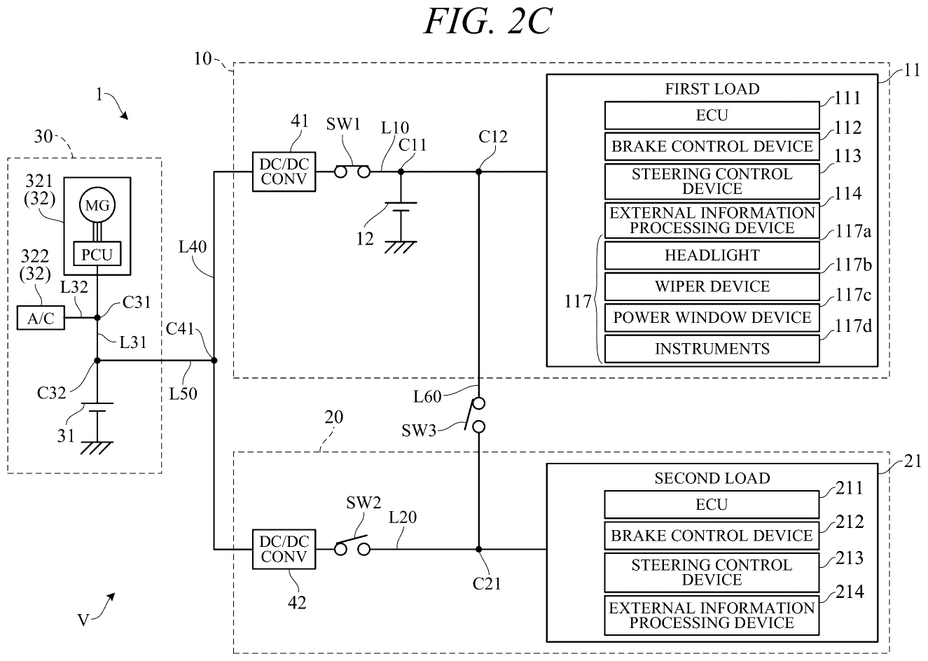

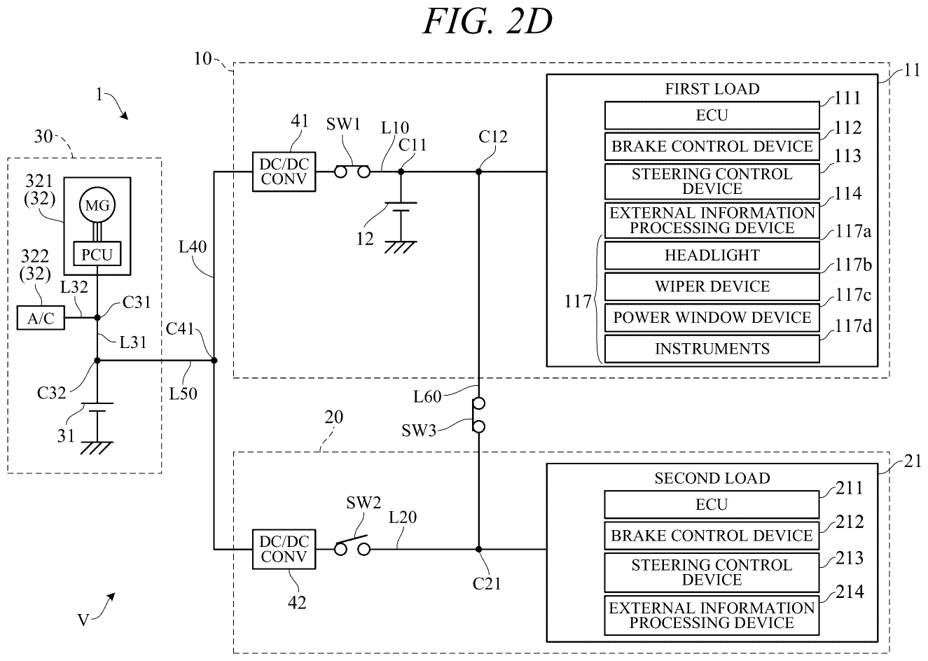

High-Voltage Failure FIG. 2A is a schematic diagram illustrating the vehicle power supply system at the time of a high-voltage failure. A state where the first power supply 41 and the second power supply 42 cannot receive power supply from the high-voltage power supply system 30 due to occurrence of some abnormality in the high-voltage power supply 31 of the high-voltage power supply system 30 is referred to as a high-voltage failure.

When a switching control signal is no longer input from the ECU 111 that has detected the high-voltage failure, the switch SW1 disconnects the power line L10 between the first power supply 41 and the first load 11. As described above, the switch SW1 is a normally open type switch.

Similarly, when a switching control signal is no longer input from the ECU 211 that has detected the high-voltage failure, the switch SW2 disconnects the power line L20 between the second power supply 42 and the second load 21. As described above, the switch SW2 is a normally open type switch.

When a switching control signal is no longer input from the ECU 111 or the ECU 211 that has detected the high-voltage failure (or another control device that operates by receiving power from the high-voltage power supply 31), the switch SW3 connects the connection line L60 between the first power supply system 10 and the second power supply system 20. As described above, the switch SW3 is a normally closed type switch.

Setting the switches SW1, SW2, and SW3 to the switching state illustrated in FIG. 2A is referred to as first setting during failure. In the first setting during failure, the first power supply 41 and the first load 11 are disconnected by the switch SW1 in the off state. In addition, the second power supply 42 and the second load 21 are disconnected by the switch SW2 in the off state. Further, the first power supply system 10 and the second power supply system 20 are connected by the switch SW3 in the on state.

Furthermore, the first battery 12 connected to the power line L10 of the first power supply system 10 supplies power necessary for the operation of the first load 11 to the first load 11, and supplies power necessary for the operation of the second load 21 of the second power supply system 20 to the second load 21 via the connection line L60 and the switch SW3 as a system connection unit.

With such a configuration, it is possible to realize the vehicle power supply system 1 having redundancy such that even in a case where the power supply from the high-voltage power supply system 30 to the first power supply system 10 and the second power supply system 20 is stopped due to the high-voltage failure, the function regarding the execution of the MRM which is minimum travel operations, stop operations, and driving control necessary for safely moving the vehicle V to a road shoulder or the like and stopping the vehicle Vis maintained by the function of the first load 11 or the second load 21, and traffic safety is further improved. At this time, the power supply source to the first load 11 and the second load 21 may be only the first battery 12 provided in the first power supply system 10, and the number of batteries can be reduced as compared with a case where each of the first power supply system 10 and the second power supply system 20 includes a battery, which can contribute to miniaturization and cost reduction of the vehicle power supply system.

Note that the switching state of the switches SW1, SW2, and SW3 illustrated in FIG. 2A may also be applied to a case where, although the power of 200 [V] is supplied from the high-voltage power supply system 30 to the first power supply 41 of the first power supply system 10 and the second power supply 42 of the second power supply system 20, some abnormality occurs in both the first power supply 41 and the second power supply 42, so that a voltage 12 [V] being DC-DC converted cannot be output from both the first power supply 41 and the second power supply 42.

### First Load Abnormality

FIG. 2B is a schematic diagram illustrating the vehicle power supply system when the first load 11 is abnormal. A state where a ground fault or a short circuit occurs in the first load 11 of the first power supply system 10 due to occurrence of some abnormality in the first load 11 is referred to as a first load abnormality. In the following description, the first load abnormality may be referred to as a Gr1 ground fault.

When a switching control signal is no longer input from the ECU 111 that has detected the first load abnormality, the switch SW1 disconnects the power line L10 between the first power supply 41 and the first load 11. As described above, the switch SW1 is a normally open type switch.

When a switching control signal is continuously input from the ECU 211 (or another control device that operates by receiving power from the high-voltage power supply 31), the switch SW2 maintains the connection of the power line L20 between the second power supply 42 and the second load 21. As described above, the switch SW2 is a normally open type switch.

When a switching control signal is continuously input from the ECU 111 or the ECU 211 (or another control device that operates by receiving power from the high-voltage power supply 31), the switch SW3 maintains the disconnection of the connection line L60 between the first power supply system 10 and the second power supply system 20. As described above, the switch SW3 is a normally closed type switch.

Setting the switches SW1, SW2, and SW3 to the switching state illustrated in FIG. 2B is referred to as second setting during failure. In the second setting during failure, the power supply from the first power supply 41 to the first load 11 in which the ground fault or the short circuit has occurred is disconnected by the switch SW1 in the off state. On the other hand, the power supply from the second power supply 42 to the second load 21 is maintained by the switch SW2 in the on state. Further, the disconnection between the first power supply system 10 and the second power supply system 20 is maintained by the switch SW3 in the off state.

With such a configuration, it is possible to realize the vehicle power supply system 1 having redundancy such that even in a case where the function of the first load 11 is stopped due to the first load abnormality, the function regarding the execution of the MRM which is minimum travel operations, stop operations, and driving control necessary for safely moving the vehicle V to a road shoulder or the like and stopping the vehicle V is maintained by the function of the second load 21, and traffic safety is further improved.

Note that the switching state of the switches SW1, SW2, and SW3 illustrated in FIG. 2B may also be applied to a case where, although the power of 200 [V] is supplied from the high-voltage power supply system 30 to the first power supply 41 of the first power supply system 10, some abnormality occurs in the first power supply 41, so that a voltage of 12 [V] being DC-DC converted cannot be output from the first power supply 41 (may be referred to as first power supply abnormality), and a case where some abnormality occurs in the first battery 12 or a charge/discharge control circuit (not illustrated) provided side by side with the first battery 12 (may be referred to as first battery abnormality).

### Second Load Abnormality

FIG. 2C is a schematic diagram illustrating the vehicle power supply system when the second load 21 is abnormal. A state where a ground fault or a short circuit occurs in the second load 21 of the second power supply system 20 due to occurrence of some abnormality in the second load 21 is referred to as a second load abnormality. In the following description, the second load abnormality may be referred to as a Gr2 ground fault.

When a switching control signal is continuously input from the ECU 111, the switch SW1 maintains the connection of the power line L10 between the first power supply 41 and the first load 11. As described above, the switch SW1 is a normally open type switch.

When a switching control signal is no longer input from the ECU 211 that has detected the second load abnormality (or another control device that operates by receiving power from the high-voltage power supply 31), the switch SW2 disconnects the power line L20 between the second power supply 42 and the second load 21. As described above, the switch SW2 is a normally open type switch.

When a switching control signal is continuously input from the ECU 111 or the ECU 211 (or another control device that operates by receiving power from the high-voltage power supply 31), the switch SW3 maintains the disconnection of the connection line L60 between the first power supply system 10 and the second power supply system 20. As described above, the switch SW3 is a normally closed type switch.

Setting the switches SW1, SW2, and SW3 to the switching state illustrated in FIG. 2C is referred to as third setting during failure. In the third setting during failure, the power supply from the second power supply 42 to the second load 21 in which the ground fault or the short circuit has occurred is disconnected by the switch SW2 in the off state. On the other hand, the power supply from the first power supply 41 to the first load 11 is maintained by the switch SW1 in the on state. Further, the disconnection between the first power supply system 10 and the second power supply system 20 is maintained by the switch SW3 in the off state.

With such a configuration, it is possible to realize the vehicle power supply system 1 having redundancy such that even in case where the function of the second load 21 is stopped due to the second load abnormality, the function regarding the execution of the MRM which is minimum travel operations, stop operations, and driving control necessary for safely moving the vehicle V to a road shoulder or the like and stopping the vehicle V is maintained by the function of the first load 11, and traffic safety is further improved.

### Second Power Supply Abnormality

FIG. 2D is a schematic diagram illustrating the vehicle power supply system when the second power supply 42 is abnormal. A case where a voltage of 12 [V] being DC-DC converted cannot be output from the second power supply 42 of the second power supply system 20 due to occurrence of some abnormality in the second power supply 42 is referred to as a second power supply abnormality.

When a switching control signal is continuously input from the ECU 111, the switch SW1 maintains the connection of the power line L10 between the first power supply 41 and the first load 11. As described above, the switch SW1 is a normally open type switch.

When a switching control signal is no longer input from the ECU 211 that has detected the second power supply abnormality (or another control device that operates by receiving power from the high-voltage power supply 31), the switch SW2 disconnects the power line L20 between the second power supply 42 and the second load 21. As described above, the switch SW2 is a normally open type switch.

When a switching control signal is no longer input from the ECU 111 or the ECU 211 that has detected the second power supply abnormality (or another control device that operates by receiving power from the high-voltage power supply 31), the switch SW3 connects the connection line L60 between the first power supply system 10 and the second power supply system 20. As described above, the switch SW3 is a normally closed type switch.

Setting the switches SW1, SW2, and SW3 to the switching state illustrated in FIG. 2D is referred to as fourth setting during failure. In the fourth setting during failure, the second power supply 42 and the second load 21 are disconnected by the switch SW2 in the off state. On the other hand, the power supply from the first power supply 41 to the first load 11 is maintained by the switch SW1 in the on state. Further, the first power supply system 10 and the second power supply system 20 are connected by the switch SW3 in the on state.

Furthermore, the first power supply 41 supplies power necessary for the operation of the first load 11 to the first load 11, and supplies power necessary for the operation of the second load 21 of the second power supply system 20 to the second load 21 via the connection line L60 and the switch SW3 as a system connection unit. With such a configuration, it is possible to realize the vehicle power supply system 1 having the redundancy such that even in a case where the power supply in the second power supply system 20 is stopped due to the second power supply abnormality, the function regarding the execution of the MRM which is minimum travel operations, stop operations, and driving control necessary for safely moving the vehicle V to a road shoulder or the like and stopping the vehicle V is maintained by the function of the first load 11, and traffic safety is further improved.

### Description of Flowchart

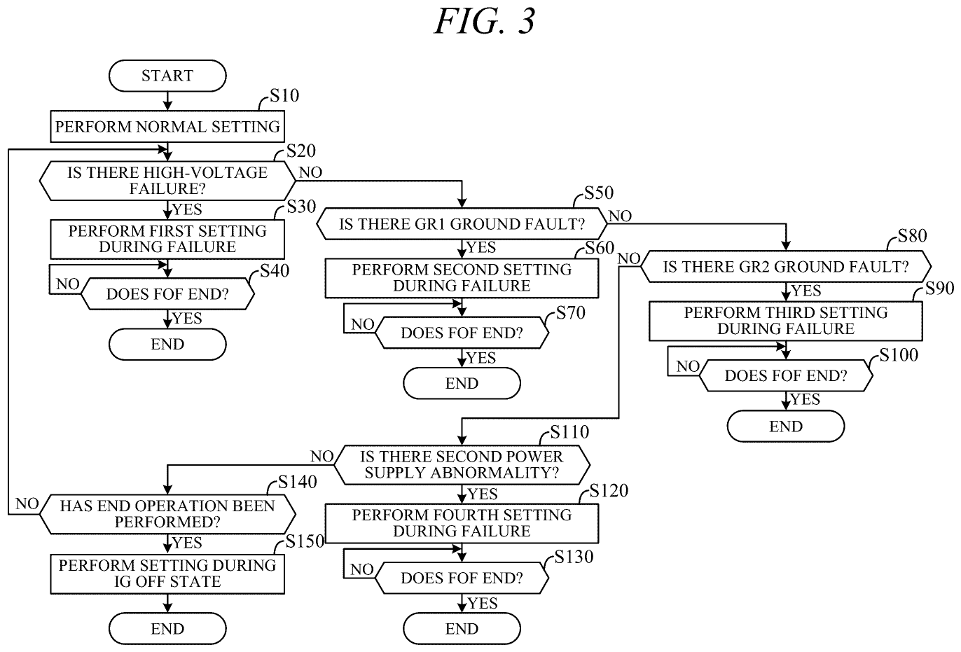

FIG. 3 is a flowchart illustrating a flow of the switching control of the switches SW1, SW2, and SW3. A predetermined control device (ECU 111 or ECU 211 (or another control device that operates by receiving power from the high-voltage power supply 31)) executes a switching control process in FIG. 3 on the basis of a program prepared in advance.

In a case where an ignition (IG) switch is turned on, the control device repeatedly performs the process according to FIG. 3.

In step S10, the control device performs normal setting and proceeds to step S20. The normal setting corresponds to the switching state of the switches SW1, SW2, and SW3 illustrated in FIG. 1.

In step S20, the control device determines whether or not there is a high-voltage failure. The control device makes an affirmative determination in step S20 and proceeds to step S30 if the high-voltage failure is detected, and makes a negative determination in step S20 and proceeds to step S50 if the high-voltage failure is not detected.

In step S30, the control device performs the first setting during failure, and proceeds to step $40. The first setting during failure corresponds to the switching state of the switches SW1, SW2, and SW3 illustrated in FIG. 2A.

In step S40, the control device determines whether or not a fail operational function (FOF) ends. For example, when the function continues under degraded control (MRM) while issuing a take over request (TOR), and ensuring safety until the completion of the driving takeover is accomplished, the control device makes an affirmative determination in step S40 and ends the process according to FIG. 3.

On the other hand, if the FOF is not accomplished, the control device makes a negative determination in step S40 and waits for the FOF completion.

In step S50 to which the processing proceeds if a negative determination is made in step S20, the control device determines whether or not there is a Gr1 ground fault. The control device makes an affirmative determination in step S50 and proceeds to step S60 if the first load abnormality is detected, and makes a negative determination in step S50 and proceeds to step S80 if the first load abnormality is not detected.

In step S60, the control device performs the second setting during failure, and proceeds to step S70. The second setting during failure corresponds to the switching state of the switches SW1, SW2, and SW3 illustrated in FIG. 2B.

In step S70, the control device determines whether or not the FOF ends. For example, when the function continues under the degraded control (MRM) while issuing the TOR, and ensuring safety until the completion of the driving takeover is accomplished, the control device makes an affirmative determination in step S70 and ends the process according to FIG. 3.

On the other hand, if the FOF is not accomplished, the control device makes a negative determination in step S70 and waits for the FOF completion.

In step S80 to which the processing proceeds if a negative determination is made in step S50, the control device determines whether or not there is a Gr2 ground fault. The control device makes an affirmative determination in step S80 and proceeds to step S90 if the second load abnormality is detected, and makes a negative determination in step S80 and proceeds to step S110 if the second load abnormality is not detected.

In step S90, the control device performs third setting during failure, and proceeds to step S100. The third setting during failure corresponds to the switching state of the switches SW1, SW2, and SW3 illustrated in FIG. 2C.

In step S100, the control device determines whether or not the FOF ends. For example, when the function continues under the degraded control (MRM) while issuing the TOR, and ensuring safety until the completion of the driving takeover is accomplished, the control device makes an affirmative determination in step S100 and ends the process according to FIG. 3.

On the other hand, if the FOF is not accomplished, the control device makes a negative determination in step S100 and waits for the FOF completion.

In step S110 to which the processing proceeds if a negative determination is made in step S80, the control device determines whether or not there is a second power supply abnormality. The control device makes an affirmative determination in step S110 and proceeds to step S120 if the second power supply abnormality is detected, and makes a negative determination in step S110 and proceeds to step S140 if the second power supply abnormality is not detected.

In step S120, the control device performs fourth setting during failure, and proceeds to step S130. The fourth setting during failure corresponds to the switching state of the switches SW1, SW2, and SW3 illustrated in FIG. 2D.

In step S130, the control device determines whether or not the FOF ends. For example, when the function continues under the degraded control (MRM) while issuing the TOR, and ensuring safety until the completion of the driving takeover is accomplished, the control device makes an affirmative determination in step S130 and ends the process according to FIG. 3.

On the other hand, if the FOF is not accomplished, the control device makes a negative determination in step S130 and waits for the FOF completion.

In step S140 to which the processing proceeds if a negative determination is made in step S110, the control device determines whether or not an end operation has been performed. If the ignition (IG) switch is turned off, the control device makes an affirmative determination in step S140 and proceeds to step S150, and if the ignition (IG) switch is not turned off, the control device makes a negative determination in step S140 and returns to step S20.

In step S150, the control device performs setting during the IG off state and ends the process according to FIG. 3. The switching state of the switches SW1, SW2, and SW3 in the setting during the IG off state is the same as the switching state illustrated in FIG. 2A. That is, the first power supply 41 and the first load 11 are disconnected from each other by the switch SW1 in the off state. In addition, the second power supply 42 and the second load 21 are disconnected by the switch SW2 in the off state. Further, the first power supply system 10 and the second power supply system 20 are connected by the switch SW3 in the on state.

According to the above-described embodiment, the following effects can be achieved.

(1) The vehicle power supply system 1 includes: the first power supply system 10 that supplies power from the first power supply 41 to the first load 11 related to travel control of the vehicle V; the second power supply system 20 that supplies power from the second power supply 42 to the second load 21 related to the travel control of the vehicle V; the switch SW3 (more specifically, the connection line L60 and the switch SW3) as a system connection unit capable of connecting and disconnecting the first power supply system 10 and the second power supply system 20; the switch SW2 as a second power supply connection unit capable of connecting and disconnecting the second power supply 42 and the second load 21; and the ECU 211 as a control unit that switches the switch SW2 from a connection state to a disconnection state and switches the system connection unit from a disconnection state to a connection state when an abnormality is detected in the second power supply 42. The ECU 211 outputs, to the switch SW3, a switching control signal (first control signal) for switching between the connection state and the disconnection state of the switch SW3 and switches between connection and disconnection between the first power supply system 10 and the second power supply system 20. In addition, the ECU 211 outputs, to the switch SW2, a switching control signal (second control signal) for switching between the connection state and the disconnection state of the switch SW2 and switches between connection and disconnection between the second power supply 42 and the second load 21. The switch SW3 is a normally closed type switch configured to maintain the connection state when the first control signal is not input. The switch SW2 is a normally open type switch configured to maintain the disconnection state when the second control signal is not input. The ECU 211 stops outputting the first control signal and the second control signal when an abnormality of the second power supply 42 is detected.

With such a configuration, the vehicle power supply system 1 having redundancy can be realized without providing a battery in each of the first power supply system 10 and the second power supply system 20. That is, even if the power supply in the second power supply system 20 is stopped due to the abnormality of the second power supply 42, the function regarding the execution of the MRM can be maintained by the function of the first load 11. As compared with a case where each of the first power supply system 10 and the second power supply system 20 includes a battery, the vehicle power supply system 1 according to the embodiment can reduce the number of batteries and can contribute to miniaturization of the system and cost reduction.

(2) The vehicle power supply system 1 of (1) further includes the switch SW1 as a first power supply connection unit capable of connecting and disconnecting the first power supply 41 and the first load 11. The first power supply system 10 includes the first battery 12 capable of supplying power to the first load 11, and the ECU 111 further switches the switch SW1 from the connection state to the disconnection state when an abnormality is detected in the first power supply 41. The ECU 211 outputs, to the switch SW1, a switching control signal (third control signal) for switching between the connection state and the disconnection state of the switch SW1 and switches between connection and disconnection between the first power supply 41 and the first load 11. The switch SW1 is a normally open type switch configured to maintain the disconnection state when the third control signal is not input. The ECU 211 stops outputting the third control signal when abnormality of the first power supply 41 is detected.

With such a configuration, even if the power supply in the first power supply system 10 is stopped due to the abnormality of the first power supply 41, the function regarding the execution of the MRM can be maintained by the function of the first load 11 or the second load 21.

(3) In the vehicle power supply system 1 of (2), the first load 11 includes the ECU 111 for AD, the brake control device 112, the steering control device 113, and the external information processing device 114 as a first control device related to the steering operation or the brake operation of the vehicle V, and the second load 21 includes the ECU 211 for ADAS, the brake control device 212, the steering control device 213, and the external information processing device 214 as the second control device related to the travel assistance of the vehicle V.

Since the functions of the first load 11 and the second load 21 overlap with each other as described above, even if any one of the first load 11 and the second load 21 stops functioning, the function regarding the execution of the MRM can be maintained by the function of the other load.

(4) In the vehicle power supply system 1 of (3), each of the first power supply 41 and the second power supply 42 converts power from the high-voltage power supply 31 as a second battery that supplies driving power of the vehicle V, and generates power to be supplied to the first load 11 and the second load 21.

Since the power to be supplied to the first load 11 and the second load 21, which are auxiliary loads, is generated on the basis of the power supplied from the large-capacity high-voltage power supply 31 that supplies larger power for driving a vehicle than the power required by the auxiliary loads, the function regarding the execution of the MRM can be maintained without power shortage.

(5) In the vehicle power supply system 1 of (4), the switch SW3 as the system connection unit operates with power supplied from one of the high-voltage power supply 31, and the first power supply system 10 or the second power supply system 20, and the switch SW2 as the second power supply connection unit operates with power supplied from one of the high-voltage power supply 31 and the second power supply system 20.

With this configuration, it is possible to provide redundancy so that each of the switches SW2 and SW3 is reliably controlled to be switched on the basis of power from a plurality of power supplies.

The above embodiment can be modified into various forms. Hereinafter, modifications will be described.

### First Modification

The second power supply system 20 in the embodiment may include a capacitor (also referred to as a supercapacitor) for preventing instantaneous interruption of the power supplied to the second load 21.

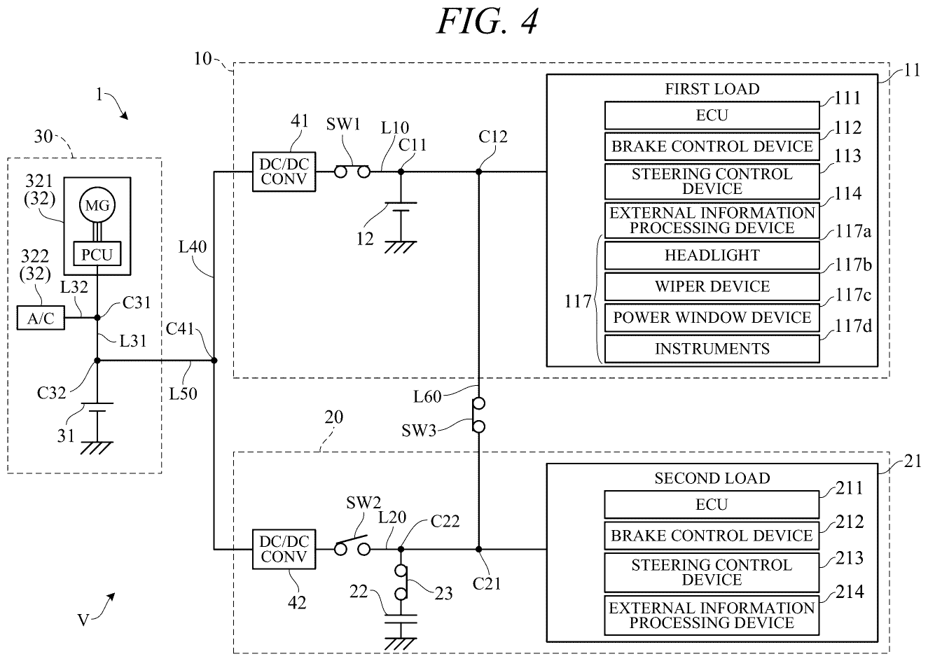

FIG. 4 is a schematic diagram illustrating the vehicle power supply system 1 according to a first modification, and illustrates the fourth setting during failure corresponding to FIG. 2D. In the first modification, in the fourth setting during failure performed during the second power supply abnormality, the switches SW1, SW2, and SW3 are set to the switching state illustrated in FIG. 4.

In FIG. 4, the capacitor 22 is connected via the switch 23 to the contact point C22 provided on the switch SW2 side on the power line L20. For example, the switch 23 is controlled to be switched to an off state only when an ignition (IG) switch is off and to be always switched to an on state when the ignition (IG) switch is on.

The capacitor 22 is configured to be repeatedly charged and discharged, and one electrode is connected to the contact point C22 of the power line L20 via the switch 23, and the other electrode is connected to a ground line having a reference potential of the vehicle power supply system 1.

In the fourth setting during failure, the second power supply 42 and the second load 21 are disconnected by the switch SW2 in the off state. On the other hand, the power supply from the first power supply 41 to the first load 11 is maintained by the switch SW1 in the on state. Further, the first power supply system 10 and the second power supply system 20 are connected by the switch SW3 in the on state.

In the vehicle power supply system 1 according to the first modification, the capacitor 22 supplies power to the second load 21 such that the power supplied to the second load 21 is not temporarily interrupted (may be referred to as instantaneous interruption) until the power from the first power supply system 10 is supplied to the second load 21 via the system connection unit (the connection line L60 and the switch SW3) after the abnormality of the second power supply 42 of the second power supply system 20 occurs.

According to the first modification described above, the following effects can be obtained in addition to the effects obtained by the vehicle power supply system 1 of (1) according to the embodiment.

That is, in the vehicle power supply system 1, the second power supply system 20 further includes the capacitor 22 capable of supplying power to the second load 21 during the transition time from the disconnection state to the connection state of the switch SW3 as the system connection unit.

With such a configuration, even if the power supply from the second power supply 42 to the second power supply system 20 is stopped due to the second power supply abnormality, the power is supplied to the second load 21 without instantaneous interruption, so that the function regarding the execution of the MRM can be stably maintained by the function of the second load 21.

### Second Modification

The emergency non-priority auxiliary load 117 included in the first power supply system 10 in the embodiment may be excluded from the first power supply system 10 and included as a third load in a newly provided third power supply system.

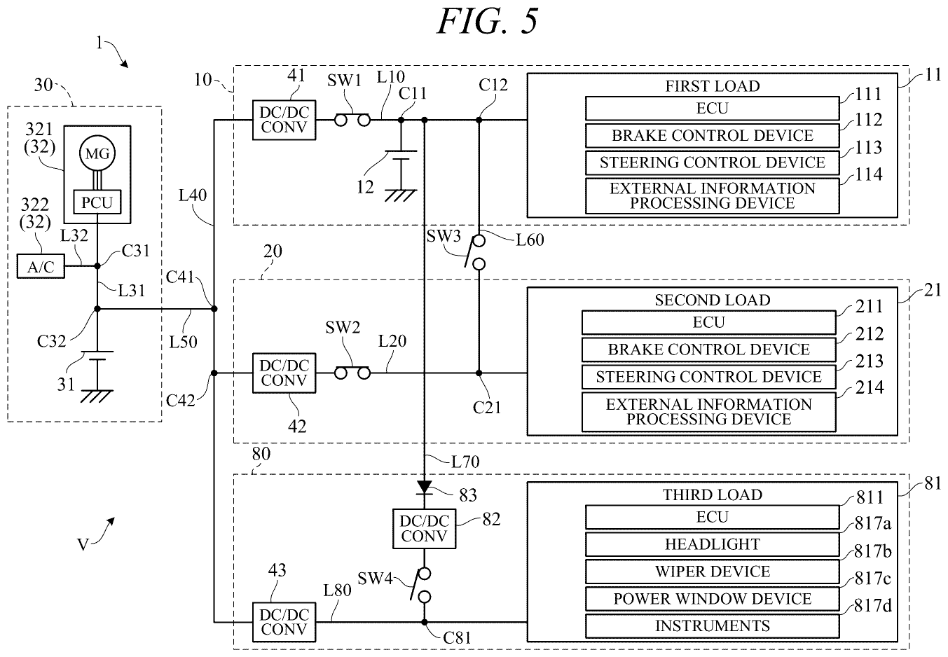

FIG. 5 is a schematic diagram illustrating the vehicle power supply system 1 according to a second modification, and illustrates setting during the normal condition corresponding to FIG. 1. In the second modification, in the setting performed during the normal condition, the switches SW1, SW2, SW3, and SW4 are set to the switching state illustrated in FIG. 5.

In the second modification, the switching state of the switches SW1, SW2, SW3, and SW4 in the setting during the IG off state is as follows. That is, the first power supply 41 and the first load 11 are disconnected from each other by the switch SW1 in the off state. In addition, the second power supply 42 and the second load 21 are disconnected by the switch SW2 in the off state. The first power supply system 10 and the second power supply system 20 are connected by the switch SW3 in the on state. Further, a fourth power supply 82 and a third load 81 to be described later are connected by the switch SW4 in the on state.

The first power supply system 10 in FIG. 5 corresponds to the first power supply system 10 in FIG. 1. However, the first power supply system 10 of FIG. 5 is different from the first power supply system 10 of FIG. 1 in that the first power supply 41 supplies power at a DC voltage 48 [V], that the first load 11 operates at a DC voltage 48 [V], that the emergency non-priority auxiliary load 117 is omitted from the first load 11, and that the first battery 12 outputs power at a DC voltage 48 [V].

The second power supply system 20, the high-voltage power supply system 30, and the connection line L60 and the switch SW3 as system connection units in FIG. 5 correspond to the second power supply system 20, the high-voltage power supply system 30, and the connection line L60 and the switch SW3 as system connection units in FIG. 1, respectively. However, the second power supply system 20 of FIG. 5 is different from the second power supply system 20 of FIG. 1 in that the second power supply 42 supplies power at a DC voltage 48 [V] and that the second load 21 operates at a DC voltage 48 [V].

### Third Power Supply System

A power supply system that supplies power to the third load 81 will be referred to as a third power supply system 80. The third power supply system 80 includes a third power supply 43, the third load 81, and the fourth power supply 82, and the third power supply 43 and the third load 81 are connected by a power line L80.

### Third Power Supply

The third power supply 43 includes a DC-DC converter that converts a DC voltage (for example, 200 [V]) supplied from the high-voltage power supply system 30 into a voltage required by the third load 81. The third power supply 43 outputs a DC voltage (12 [V]) after DC-DC conversion.

### Third Load

The third load 81 corresponds to the emergency non-priority auxiliary load 117 included in the first power supply system 10 of FIG. 1. More specifically, a headlight 817a, a wiper device 817b, a power window device 817c, and instruments 817d in FIG. 5 correspond to the headlight 117a, the wiper device 117b, the power window device 117c, and the instruments 117d in FIG. 1, respectively. Note that the third load 81 includes an ECU 811 that controls each load.

### Fourth Power Supply

The fourth power supply 82 steps down the DC voltage 48 [V] supplied from the first power supply system 10 to a DC voltage 12 [V].

The fourth power supply 82 and the first power supply system 10 are connected by a power line L70. A diode 83 for preventing backflow is inserted into the power line L70 on the fourth power supply 82 side.

The switch SW4 is provided between the fourth power supply 82 and the contact point C81 provided on the power line L80. When the switch SW4 is in the on state, the power output from the fourth power supply 82 is supplied to the third load 81. When the switch SW4 is in the off state, the fourth power supply 82 and the power line L80 are disconnected.

The switch SW4 is, for example, a normally closed type (N.C. type) switch including a semiconductor switch. The switch SW4 can be switched between the on and off states in a case where the switching control signal is input. Therefore, with a configuration that the switching control signal is input to the switch SW4 during the normal condition, connection/disconnection between the fourth power supply 82 and the power line L80 can be switched.

Note that the switching of the switch SW4 is controlled by using, for example, power from one of the third power supply 43 and the fourth power supply 82. In other words, during the normal condition, the ECU 811 that has received power from the third power supply 43 of the third power supply system 80 controls the switching of the switch SW4. On the other hand, in a case where the ECU 811 that has performed switching control cannot receive power supply from the third power supply 43, another control device (not illustrated) that operates by receiving power from the fourth power supply 82 controls the switching of the switch SW4.

### Operation When Vehicle Power Supply System is Abnormal

Next, an operation of the vehicle power supply system 1 in a case where an abnormality occurs in the vehicle power supply system 1, that is, a case where the vehicle power supply system 1 is different from the normal condition will be described. Specifically, the switching control of the switches SW1, SW2, SW3, and SW4 will be described.

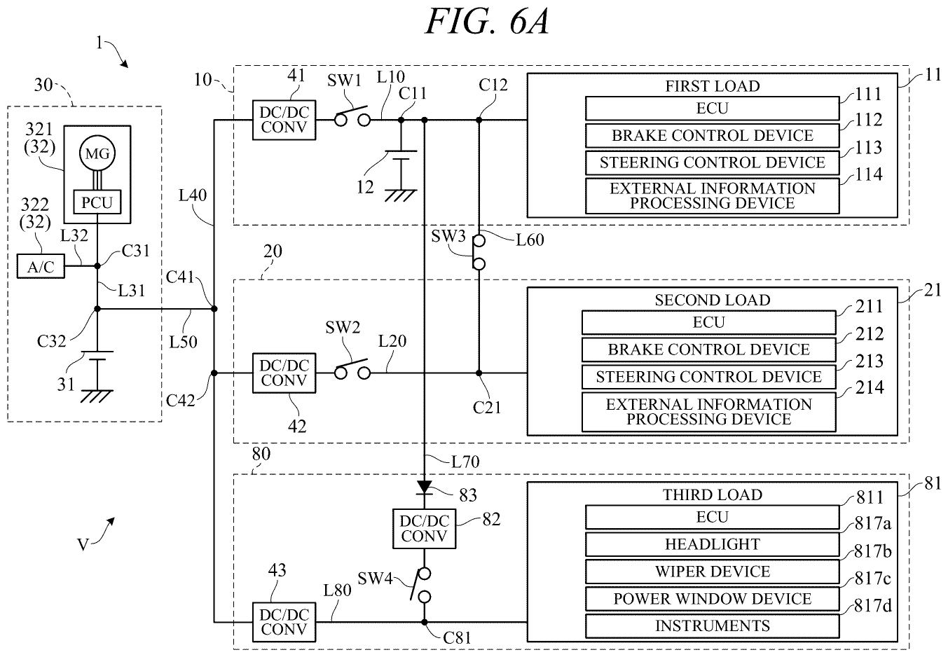

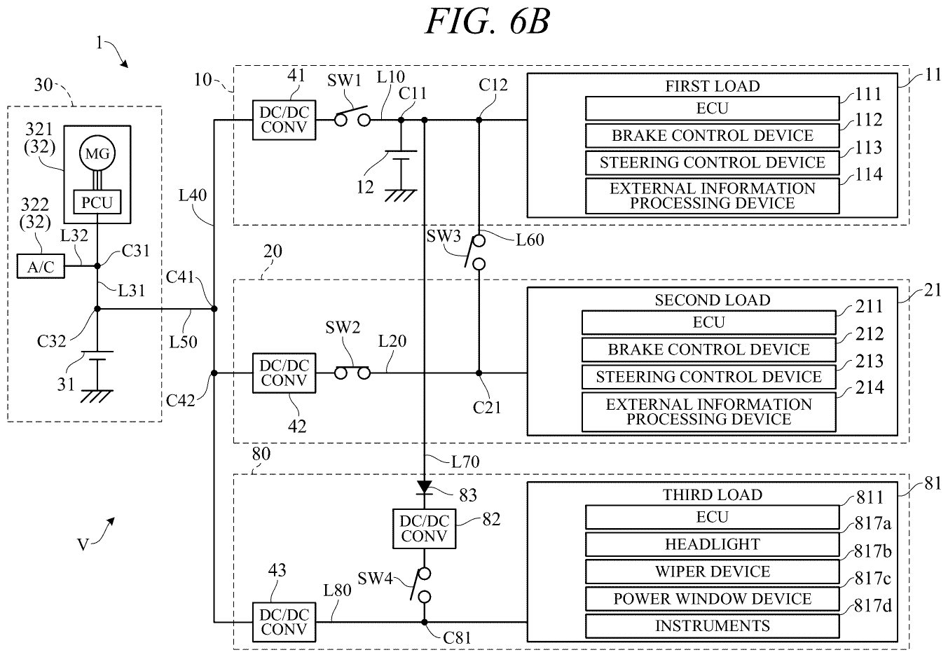

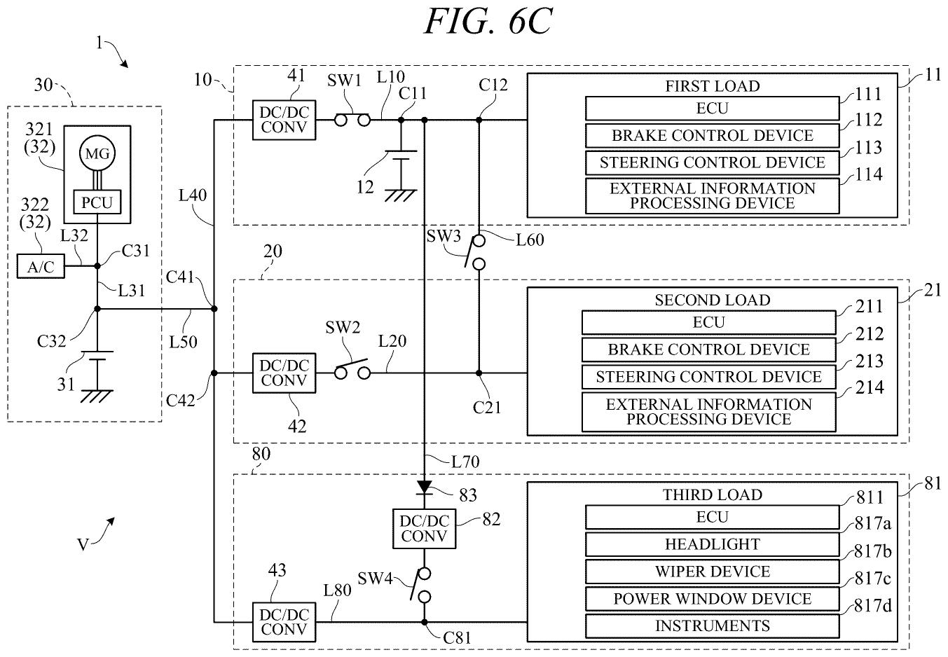

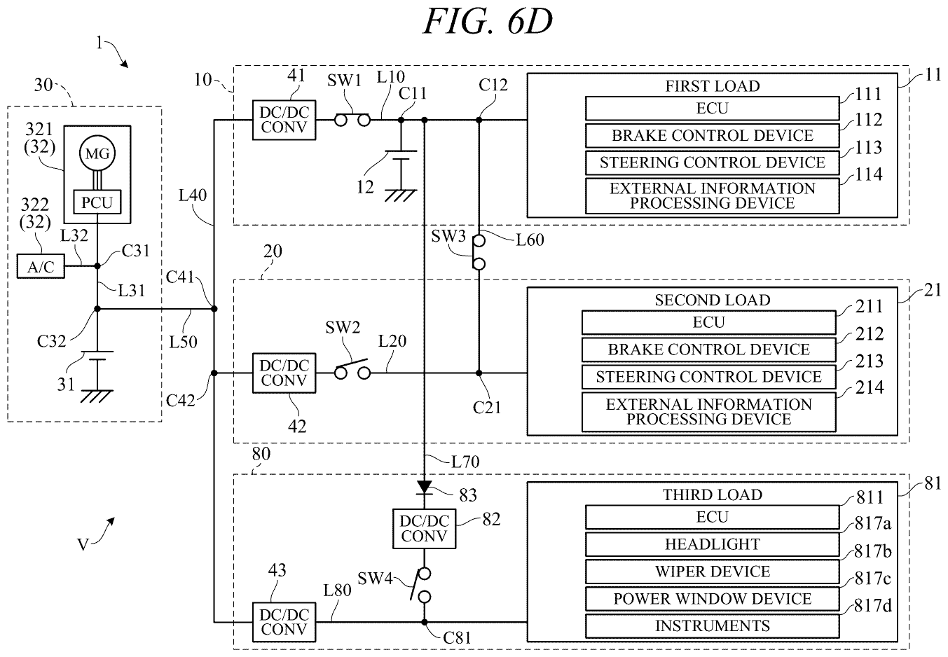

High-Voltage Failure FIG. 6A is a schematic diagram illustrating the vehicle power supply system at the time of a high-voltage failure. Similarly to the case of FIG. 2A, when a switching control signal is no longer input from the ECU 111 that has detected the high-voltage failure, the switch SW1 disconnects the power line L10 between the first power supply 41 and the first load 11. As described above, the switch SW1 is a normally open type switch.

Similarly to the case of FIG. 2A, when a switching control signal is no longer input from the ECU 211 that has detected the high-voltage failure, the switch SW2 disconnects the power line L20 between the second power supply 42 and the second load 21. As described above, the switch SW2 is a normally open type switch.

Similarly to the case of FIG. 2A, when a switching control signal is no longer input from the ECU 111 or the ECU 211 that has detected the high-voltage failure (or another control device that operates by receiving power from the high-voltage power supply 31), the switch SW3 connects the connection line L60 between the first power supply system 10 and the second power supply system 20. As described above, the switch SW3 is a normally closed type switch.

Even in a case where a switching control signal is not input from the ECU 811 that has detected the high-voltage failure or the power from the third power supply 43 cannot be received due to the high-voltage failure, the switch SW4 maintains the disconnection state between the fourth power supply 82 and the power line L80 by a switching control signal from another control device that operates by receiving power from the fourth power supply 82.

Note that in a case where the high-voltage failure is recovered, the ECU 811 that has received power from the third power supply 43 takes over the switching control from another control device that operates by receiving power from the fourth power supply 82, and maintains the off state of the switch SW4 (the disconnection state between the fourth power supply 82 and the power line L80).

In the second modification, setting the switches SW1, SW2, SW3, and SW4 to the switching state illustrated in FIG. 6A is referred to as first setting during failure. In the first setting during failure, the first power supply 41 and the first load 11 are disconnected by the switch SW1 in the off state. In addition, the second power supply 42 and the second load 21 are disconnected by the switch SW2 in the off state. Further, the first power supply system 10 and the second power supply system 20 are connected by the switch SW3 in the on state. Furthermore, the fourth power supply 82 and the power line L80 are disconnected by the switch SW4 in the off state.

With such the first setting during failure, the first battery 12 connected to the power line L10 of the first power supply system 10 supplies power necessary for the operation of the first load 11 to the first load 11, and supplies power necessary for the operation of the second load 21 of the second power supply system 20 to the second load 21 via the connection line L60 and the switch SW3 as a system connection unit.

With such a configuration, it is possible to realize the vehicle power supply system 1 having redundancy such that even in a case where the power supply from the high-voltage power supply system 30 to the first power supply system 10 and the second power supply system 20 is stopped due to the high-voltage failure, the function regarding the execution of the MRM which is minimum travel operations, stop operations, and driving control necessary for safely moving the vehicle V to a road shoulder or the like and stopping the vehicle Vis maintained by the function of the first load 11 or the second load 21, and traffic safety is further improved.

Note that the switching state of the switches SW1, SW2, SW3, and SW4 illustrated in FIG. 6A may be applied to a case where, although the power of 200 [V] is supplied from the high-voltage power supply system 30 to the first power supply 41 of the first power supply system 10 and the second power supply 42 of the second power supply system 20, some abnormality occurs in the first power supply 41 and the second power supply 42, so that a voltage of 48 [V] being DC-DC converted cannot be output from the first power supply 41 and the second power supply 42.

### First Load Abnormality

FIG. 6B is a schematic diagram illustrating the vehicle power supply system when the first load 11 is abnormal. A state where a ground fault or a short circuit occurs in the first load 11 of the first power supply system 10 due to occurrence of some abnormality in the first load 11 is referred to as a first load abnormality (or Gr1 ground fault).

Similarly to the case of FIG. 2B, when a switching control signal is no longer input from the ECU 111 that has detected the first load abnormality, the switch SW1 disconnects the power line L10 between the first power supply 41 and the first load 11. As described above, the switch SW1 is a normally open type switch.

Similarly to the case of FIG. 2B, when a switching control signal is continuously input from the ECU 211 (or another control device that operates by receiving power from the high-voltage power supply 31), the switch SW2 maintains the connection of the power line L20 between the second power supply 42 and the second load 21. As described above, the switch SW2 is a normally open type switch.

Similarly to the case of FIG. 2B, when a switching control signal is continuously input from the ECU 111 or the ECU 211 (or another control device that operates by receiving power from high-voltage power supply 31), the switch SW3 maintains the disconnection of the connection line L60 between the first power supply system 10 and the second power supply system 20. As described above, the switch SW3 is a normally closed type switch.

The switch SW4 is a normally closed type switch that maintains the disconnection state between the fourth power supply 82 and the power line L80 by a switching control signal from the ECU 811 that operates by receiving power from the third power supply 43.

In the second modification, setting the switches SW1, SW2, SW3, and SW4 to the switching state illustrated in FIG. 6B is referred to as second setting during failure. In the second setting during failure, the power supply from the first power supply 41 to the first load 11 in which the ground fault or the short circuit has occurred is disconnected by the switch SW1 in the off state. On the other hand, the power supply from the second power supply 42 to the second load 21 is maintained by the switch SW2 in the on state. Further, the disconnection between the first power supply system 10 and the second power supply system 20 is maintained by the switch SW3 in the off state.

With such a configuration, it is possible to realize the vehicle power supply system 1 having redundancy such that even in a case where the function of the first load 11 is stopped due to the first load abnormality, the function regarding the execution of the MRM which is minimum travel operations, stop operations, and driving control necessary for safely moving the vehicle V to a road shoulder or the like and stopping the vehicle V is maintained by the function of the second load 21, and traffic safety is further improved.

Note that the switching state of the switches SW1, SW2, SW3, and SW4 illustrated in FIG. 6B may also be applied to a case where, although the power of 200 [V] is supplied from the high-voltage power supply system 30 to the first power supply 41 of the first power supply system 10, some abnormality occurs in the first power supply 41, so that a voltage of 48 [V] being DC-DC converted cannot be output from the first power supply 41 (may be referred to as first power supply abnormality), and a case where some abnormality occurs in the first battery 12 or a charge/discharge control circuit (not illustrated) provided side by side with the first battery 12 (may be referred to as first battery abnormality).

### Second Load Abnormality

FIG. 6C is a schematic diagram illustrating the vehicle power supply system when the second load 21 is abnormal. A state where a ground fault or a short circuit occurs in the second load 21 of the second power supply system 20 due to occurrence of some abnormality in the second load 21 is referred to as a second load abnormality (or Gr2 ground fault).

Similarly to the case of FIG. 2C, when a switching control signal is continuously input from the ECU 111, the switch SW1 maintains the connection of the power line L10 between the first power supply 41 and the first load 11. As described above, the switch SW1 is a normally open type switch.

Similarly to the case of FIG. 2C, when a switching control signal is no longer input from the ECU 211 that has detected the second load abnormality (or another control device that operates by receiving power from the high-voltage power supply 31), the switch SW2 disconnects the power line L20 between the second power supply 42 and the second load 21. As described above, the switch SW2 is a normally open type switch.

Similarly to the case of FIG. 2C, when a switching control signal is continuously input from the ECU 111 or the ECU 211 (or another control device that operates by receiving power from high-voltage power supply 31), the switch SW3 maintains the disconnection of the connection line L60 between the first power supply system 10 and the second power supply system 20. As described above, the switch SW3 is a normally closed type switch.

The switch SW4 is a normally closed type switch that maintains the disconnection state between the fourth power supply 82 and the power line L80 by a switching control signal from the ECU 811 that operates by receiving power from the third power supply 43.

In the second modification, setting the switches SW1, SW2, SW3, and SW4 to the switching state illustrated in FIG. 6C is referred to as third setting during failure. In the third setting during failure, the power supply from the second power supply 42 to the second load 21 in which the ground fault or the short circuit has occurred is disconnected by the switch SW2 in the off state. On the other hand, the power supply from the first power supply 41 to the first load 11 is maintained by the switch SW1 in the on state. Further, the disconnection between the first power supply system 10 and the second power supply system 20 is maintained by the switch SW3 in the off state. Furthermore, the fourth power supply 82 and the power line L80 are disconnected by the switch SW4 in the off state.

With such a configuration, it is possible to realize the vehicle power supply system 1 having redundancy such that even in case where the function of the second load 21 is stopped due to the second load abnormality, the function regarding the execution of the MRM which is minimum travel operations, stop operations, and driving control necessary for safely moving the vehicle V to a road shoulder or the like and stopping the vehicle V is maintained by the function of the first load 11, and traffic safety is further improved.

### Second Power Supply Abnormality

FIG. 6D is a schematic diagram illustrating the vehicle power supply system when the second power supply 42 is abnormal. A case where a voltage of 48 [V] being DC-DC converted cannot be output from the second power supply 42 of the second power supply system 20 due to occurrence of some abnormality in the second power supply 42 is referred to as a second power supply abnormality.

Similarly to the case of FIG. 2D, when a switching control signal is continuously input from the ECU 111, the switch SW1 maintains the connection of the power line L10 between the first power supply 41 and the first load 11. As described above, the switch SW1 is a normally open type switch.

Similarly to the case of FIG. 2D, when a switching control signal is no longer input from the ECU 211 that has detected the second power supply abnormality (or another control device that operates by receiving power from the high-voltage power supply 31), the switch SW2 disconnects the power line L20 between the second power supply 42 and the second load 21. As described above, the switch SW2 is a normally open type switch.

Similarly to the case of FIG. 2D, when a switching control signal is no longer input from the ECU 111 or the ECU 211 that has detected the second power supply abnormality (or another control device that operates by receiving power from the high-voltage power supply 31), the switch SW3 connects the connection line L60 between the first power supply system 10 and the second power supply system 20. As described above, the switch SW3 is a normally closed type switch.

The switch SW4 is a normally closed type switch that maintains the disconnection state between the fourth power supply 82 and the power line L80 by a switching control signal from the ECU 811 that operates by receiving power from the third power supply 43.

In the second modification, setting the switches SW1, SW2, SW3, and SW4 to the switching state illustrated in FIG. 6D is referred to as fourth setting during failure. In the fourth setting during failure, the second power supply 42 and the second load 21 are disconnected by the switch SW2 in the off state. On the other hand, the power supply from the first power supply 41 to the first load 11 is maintained by the switch SW1 in the on state. Further, the first power supply system 10 and the second power supply system 20 are connected by the switch SW3 in the on state.

Furthermore, the first power supply 41 supplies power necessary for the operation of the first load 11 to the first load 11, and supplies power necessary for the operation of the second load 21 of the second power supply system 20 to the second load 21 via the connection line L60 and the switch SW3 as a system connection unit. Furthermore, the disconnection between the fourth power supply 82 and the power line L80 is maintained by the switch SW4 in the off state.

With such a configuration, it is possible to realize the vehicle power supply system 1 having the redundancy such that even in a case where the power supply from the second power supply 42 to the second power supply system 20 is stopped due to the second power supply abnormality, the function regarding the execution of the MRM which is minimum travel operations, stop operations, and driving control necessary for safely moving the vehicle V to a road shoulder or the like and stopping the vehicle Vis maintained by the function of the first load 11, and traffic safety is further improved.

According to the second modification described above, the following effects can be obtained in addition to the effects obtained by the vehicle power supply system 1 according to the embodiment.

(1) In the vehicle power supply system 1, the first power supply system 10 includes the first battery 12 capable of supplying power. The vehicle power supply system further includes a third power supply system 80 that supplies power to the third load 81 not related to the travel control of the vehicle V, and a fourth power supply 82 as a power supply unit that is provided between the first power supply system 10 and the third power supply system 80, and converts the power of the first power supply system 10 and generates power to be supplied to the third load 81.

With such a configuration, even in a case where a load not related to the travel control of the vehicle V is separated as the third load 81 from the first load 11, the third load 81 can be operated by using the power supplied from the first power supply system 10 without providing a new battery in the third power supply system 80.

As compared with a case where the third power supply system 80 also includes a battery, the vehicle power supply system 1 according to the second modification can reduce the number of batteries and can contribute to miniaturization of the system and cost reduction.

(2) In the vehicle power supply system 1 of (1), the fourth power supply 82 as the power supply unit converts the power from the first battery 12 and generates power to be supplied to the third load 81.

With such a configuration, without providing a new battery in the third power supply system 80, the power supplied from the first battery 12 of the first power supply system 10 can be converted to generate power necessary for the third load 81. For example, when the IG is turned off, the power from the fourth power supply 82 is supplied to the third load 81 via the normally closed type switch SW4.

The above embodiment can be combined as desired with one or more of the above modifications. The modifications can also be combined with one another.

According to the present invention, it is possible to reduce the number of batteries without impairing the redundancy of the power supply system.

Above, while the present invention has been described with reference to the preferred embodiments thereof, it will be understood, by those skilled in the art, that various changes and modifications may be made thereto without departing from the scope of the appended claims.

What is claimed is:

1. A vehicle power supply system comprising:
a first power supply system configured to supply power from a first power supply to a first load related to travel control of a vehicle; and
a second power supply system configured to supply power from a second power supply to a second load related to the travel control of the vehicle, wherein
the vehicle power supply system further comprises:
a system connection unit capable of connecting and disconnecting the first power supply system and the second power supply system;
a power supply connection unit capable of connecting and disconnecting the second power supply and the second load; and
a microprocessor, wherein
the microprocessor is configured to, when an abnormality of the second power supply is detected, perform switching the power supply connection unit from a connection state to a disconnection state and switching the system connection unit from a disconnection state to a connection state.

2. The vehicle power supply system according to claim 1, wherein
the microprocessor is configured to further perform:
outputting, to the system connection unit, a first control signal instructing connection and disconnection between the first power supply system and the second power supply system; and
outputting, to the power supply connection unit, a second control signal instructing connection and disconnection between the second power supply and the second load,
the system connection unit is configured to maintain the connection state when the first control signal is not input,
the power supply connection unit is configured to maintain the disconnection state when the second control signal is not input, and
the microprocessor is configured to further perform stopping outputting the first control signal and the second control signal when the abnormality of the second power supply is detected.

3. The vehicle power supply system according to claim 1, wherein
the microprocessor is a first microprocessor, and
the power supply connection unit is a second power supply connection unit, wherein,
the vehicle power supply system further comprises:
a first power supply connection unit capable of connecting and disconnecting the first power supply and the first load; and
a second microprocessor, and wherein
the first power supply system includes a first battery capable of supplying power to at least the first load, and
the second microprocessor is configured to perform switching the first power supply connection unit from connection state to disconnection state when an abnormality of the first power supply is detected.

4. The vehicle power supply system according to claim 3, wherein
the second microprocessor is configured to further perform outputting, to the first power supply connection unit, a third control signal instructing connection and disconnection between the first power supply and the first load,
the first power supply connection unit is configured to maintain the disconnection state when the third control signal is not input, and
the second microprocessor is configured to further perform stopping outputting the third control signal when the abnormality of the first power supply is detected.

5. The vehicle power supply system according to claim 4, wherein
the first load includes a first control device related to a steering operation or a brake operation of the vehicle, and
the second load includes a second control device related to travel assistance of the vehicle.

6. The vehicle power supply system according to claim 5, wherein
each of the first power supply and the second power supply is configured to convert power from a second battery for supplying driving power of the vehicle to generate power to be supplied to the first load and the second load.

7. The vehicle power supply system according to claim 6, wherein
the system connection unit is further configured to operate with power supplied from one of the second battery and the first power supply system or the second power supply system, and
the second power supply connection unit is configured to operate with power supplied from one of the second battery and the second power supply system.

8. The vehicle power supply system according to claim 1, wherein
the second power supply system further includes a capacitor capable of supplying power to the second load during a transition time from the disconnection state to the connection state of the system connection unit.

9. The vehicle power supply system according to claim 1, wherein
the first power supply system includes a first battery capable of supplying power to the first load, and
the vehicle power supply system further comprises:
a third power supply system configured to supply power to a third load not related to the travel control of the vehicle and whose driving voltage is different from the first load; and
a power supply unit provided between the first power supply system and the third power supply system, and configured to convert the power supplied from the first power supply system to generate power to be supplied to the third load.

10. The vehicle power supply system according to claim 9, wherein
the power supply unit is configured to step down the voltage from the first battery to generate the power to be supplied to the third load whose driving voltage is lower than the first load.
